(19) United States
(12) Patent Application Publication
(10) Pub. No.: US 2007/0267536 A1
(43) Pub. Date: Nov. 22, 2007

(54) Method and apparatus for pre-heating an aircraft engine

(76) Inventor: Herbert Alvin Hill, Spearfish, SD (US)

Correspondence Address: Herb Hill, 506 North 5th Street, Spearfish, SD, 57783, US

(21) Appl. No.: 11/434,597

(22) Filed: May 15, 2006

Related U.S. Application Data
(60) Provisional application No. 60/644,270, filed on May 27, 2005.

(51) Int. Cl. B64D 47/00

(52) U.S. Cl. 244/1 R

(57) ABSTRACT

The present invention is an aircraft engine heating system and the associated method of its operation. The system contains an electric heater comprised of an electrical heating element, thermostat and fan. A power cord is provided for supplying electricity to the heating element and the fan. Two metal tubing adaptors attach to the front and rear of the heater. A flexible, heat-resistant tube is connected to each adaptor via metal fasteners. The front tube is inserted in to the engine intake vent of an aircraft. This tube directs warm air into the aircraft engine. The return tube leads from the other aircraft engine vent to the rear of the heat system. In this way, warm air is re-circulated through the aircraft engine, warming the engine more quickly and reducing the power demands to operate the system.

This application claims the benefit of U.S. Provisional Application No. 60/644,270, filed May 27, 2005.

### BACKGROUND OF THE INVENTION

1. Field of the Invention

This invention relates to portable heating devices. Specifically, this invention relates to an electric heater with a blower fan that has been adapted to circulate warm air through a cold airplane engine in order to heat the engine components in preparation for cold-weather flight.

2. Description of the Prior Art

In many areas of the world, temperatures fall well below freezing for extended periods each year. Extended periods of cold result in cold-soaked aircraft engines needing to be warmed prior to flight.

There are various existing methods for warming an airplane engine prior to cold-weather flight. Hangar warming requires a heated airplane hangar. This method heats the engine slowly as the engine conducts warmth from the ambient heat inside the airplane hangar. Access to a heated airplane hangar is not universal. Moreover, this requires a great deal of energy to heat the hanger itself.

An alternate method for heating an airplane engine is through use of a propane blower. Such blowers are connected to heaters fueled by small propane tanks. Said blowers' directed heat warm an airplane's engine but require propane fuel and large open spaces to protect against combustible propane fumes. Moreover, propane blowers are cumbersome to transport and cannot be taken on board the aircraft for use at different locations.

Other proprietary aircraft engine heating devices unique to certain aircraft do exist. However, all are cumbersome to use, expensive to purchase and manufacture, and are not compatible with many small aircraft.

Thus, there exists a need for an airplane engine pre-heater that is inexpensive to purchase and manufacture. There further exists a need for an airplane engine pre-heater that is portable and can be carried on an airplane to its next cold-weather destination. There further exists a need for an airplane engine pre-heater that is inexpensive to operate. There further exists a need for an airplane engine pre-heater that can be operated on a timer or thermostat so airplane engine pre-heating may take place without the presence of a pilot or other flight technician. There further exists a need for an airplane engine pre-heater that is easy to connect to the engine so as to allow successful warming.

### SUMMARY OF THE INVENTION

The present invention is an aircraft engine heating system and the associated method of its operation. The aircraft engine heating system includes an electrical heating element and fan housed within the heat-resistant body of a portable electric heater. A power cord is provided for supplying electricity to the heating element and the fan. Power is derived from an external electrical power source.

A thermostat is included in the system. The thermostat can be manually set for a desired temperature and will cycle the heating element on and off in order to maintain the desired temperature.

Two adapters are mounted to the front and rear of the heaters' body. A flexible, heat-resistant tube is connected to each adaptor by means of a metal fastener. The output tube is inserted in to the intake vent of an aircraft engine. The tube directs warm air, blown by the fan across the heater's heating element, into the aircraft engine. The return tube leads from the other aircraft vent to the rear of the heat system. In this way, warm air is re-circulated through the aircraft engine and heater, warming the engine more quickly and reducing the power demands to operate the system. It is portable, inexpensive to manufacture and operate, and easy to use.

### BRIEF DESCRIPTION OF THE DRAWINGS

For a better understanding of the present invention, reference is made to the following description of an exemplary embodiment thereof, considered in conjunction with the accompanying drawings, in which:

FIG. 1 is a side-view of an aircraft engine pre-heater.

FIG. 2 includes a side (12a), top (12b), and bottom view (12c) of the front tubing adapter.

FIG. 3 includes a side (13a), top (13b), and bottom view (13c) of the rear tubing adapter.

FIG. 4 is a side view of an electric heater with front and rear tubing adapters attached.

FIG. 5 is a side view of a metal fastener.

### DETAILED DESCRIPTION OF THE INVENTION

Portable electric heaters are commonly known and produced by various manufacturers such as Paragon Industrial Corporation of Downingtown, Pa. They typically consist of an electric heating element enclosed in a heat-resistant housing consisting of an air intake, blower fan, thermostat, power switch and power connector. These electric heaters generally have different heat settings commensurate with wattage and draw power from a standard 110 volt wall outlet.

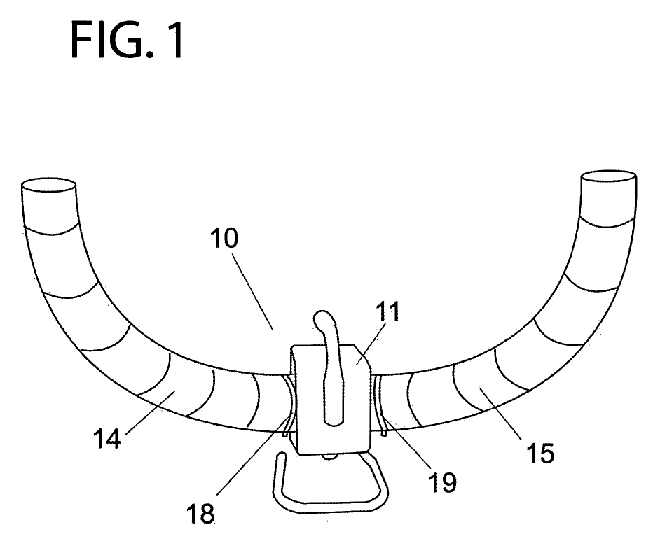

Referring now to the drawings and particularly to FIG. 1, shown therein is an airplane engine pre-heater of a first exemplary embodiment of the present invention generally indicated 10. Airplane engine pre-heater 10 of this exemplary embodiment is a portable, electrical heating device capable of warming an airplane engine prior to cold-weather flight.

FIG. 1 shows the airplane engine pre-heater 10 of the present invention having body 11. Body 11 is an electric heater constructed of a generally two-piece heat-resistant metallic or polymer frame containing a heating element, fan, air intake, thermostat, on/off switch, power connection, various internal components, ground stand and carrying handle. The body 11 may be comprised of any small electric heater with a fan that tubing adapters can be modified to fit.

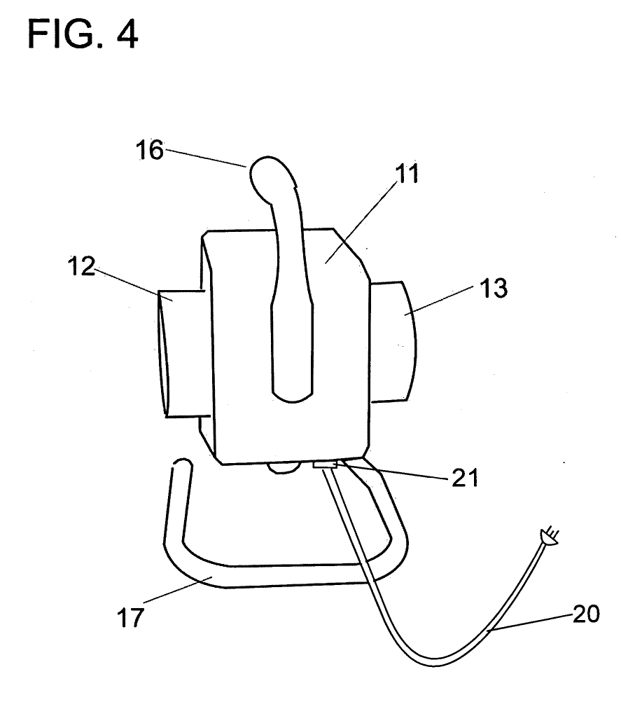

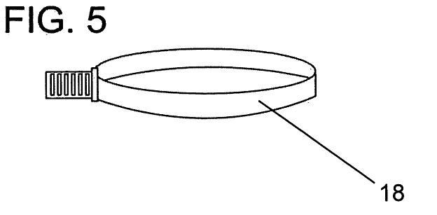

As will be appreciated, tubing adapters 12 and 13 (of FIG. 4) of the airplane engine pre-heater 10, provide durable, heat-resistant mounts for electrical heater 11 in order to connect to tubing 14 and 15. Tubing 14 and 15 attaches securely to tubing adapters 12 and 13 by means of metal fasteners 18 and 19. A close-up view of fastener 18 is depicted in FIG. 5.

Airplane engine pre-heater 10 further provides an attractive appearance due to its stylized appearance. The heater 11 and tubing 14 and 15 may be made in numerous colors and sizes. The airplane engine pre-heater is particularly well suited to an outdoor, unattended environment since its closed system protects integral internal components from direct exposure to outdoor weather elements.

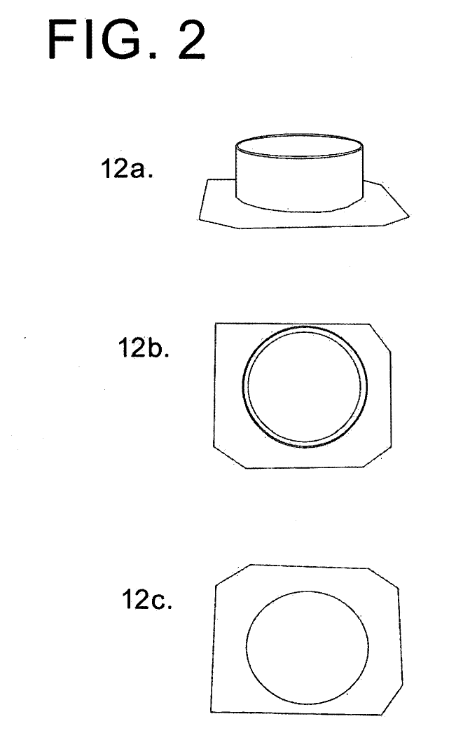

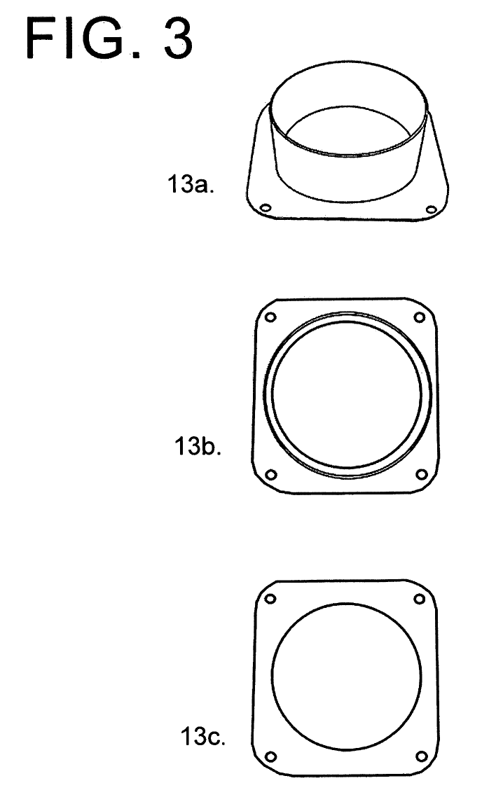

As shown in FIG. 2 and FIG. 3, this exemplary embodiment includes front tubing adapter 12 and rear tubing adapter 13. In this embodiment, tubing adapters 12 and 13 are comprised of heat-resistant metal that has been shaped and welded in order to create a one-piece metal adapter that attaches directly to the heater 11 shown in FIG. 1. Such material provides optimal strength, weather resistance, impact absorption, and heat resistance in order to achieve the desired heater to tubing connection for indoor or outdoor operation of the exemplary airplane engine pre-heater. However, any material of like environmental response may also be used for tubing adapters 12 and 13.

As shown in FIG. 4, this exemplary embodiment includes heater 11, tubing adapters 12 and 13, carrying handle 16 and placement stand 17. Handle 16 and stand 17 are optional and not integral to the operation on the present invention depending upon how one chooses to connect the system to an aircraft. Power cord 20 attaches to power connector 21. Power cord 20 provides external electrical power to the heating element and fan inside body 11.

FIG. 5 depicts a close-up view of metal fastener 18 used to attach tubing 14 and 15 (as depicted in FIG. 1) to the tubing adapters 12 and 13 in FIG. 3 and FIG. 4.

All of the above elements can be consolidated into a carrying case and are readily portable. Moreover, assembly is simple and attachment to an airplane is very easy. The system is capable of withstanding outdoor use, is inexpensive to operate and manufacture.

As will be appreciated, embodiments of the invention provide substantial advantages over conventional airplane engine heaters. The exemplary embodiment discussed herein is only one example of an airplane engine pre-heater that may be achieved by employing the principles of the invention. Numerous other embodiments of the invention may be produced that are within the scope of the present invention.

The foregoing objects are accomplished in an exemplary embodiment of the present invention by an airplane engine pre-heater consisting of a small electric heater, metal tubing adapters, flexible heat-resistant tubing, and metal fasteners.

In an exemplary embodiment of the invention, an electric heater is modified to accept tubing adapters made of heat-resistant metal. Once in place, the tubing adapters securely connect the heater to flexible, heat-resistant tubing by means of metal fasteners. The heat-resistant tubing from the front of the heater is placed inside an airplane engine intake vent. The second section of heat-resistant tubing is then run from the second aircraft engine vent to the rear adapter.

When the circuit is complete, air, blown by the electric fan, passes through a heating element and warms. The warm air is forced through the uptake tube, and into the airplane engine. The output tube then pulls the warmed air from the engine down into the rear side of the electric heater. Since the returning air is already warm, it takes less energy to warm the outgoing air. This cycle continues until the heater is manually turned off, or until the thermostat cycles the heating element off. This air circulation will warm an aircraft engine in preparation for cold-weather flight. This process happens more quickly than other conventional methods since this closed system makes full use of heated air as said heated air is recycled back into the system. In addition, the system may be operated independently, without direct supervision, either by means of a third party timer in conjunction with the heater's power cord, or by continual use via regulation by the included thermostat.

Thus, the airplane engine pre-heater of the present invention achieves the above-stated objectives, eliminates difficulties encountered in the use of prior devices and systems and attains the desirable results described herein.

In the foregoing description, certain terms have been used for brevity, clarity and understanding. However, no unnecessary limitations are to be implied therefrom, because such terms are for descriptive purposes and are intended to be broadly construed. Moreover, the descriptions and illustrations herein are by way of examples and the invention is not limited to the exact details shown and described.

In the following claims, any feature described as a means for performing a function shall be construed as encompassing any means known to those skilled in the art to be capable of performing the recited function, and shall not be limited to the structures or methods shown in the exemplary embodiment herein or mere equivalents thereof.

Having described the features, discoveries and principles of the invention, the manner in which it is constructed and operated, and the advantages and useful results attained, the new and useful structures, devices, elements, arrangements, parts, combinations, systems, equipment, operations, methods and relationships are set forth herein.

The following claims are made:

1. An airplane engine pre-heater apparatus comprising:
an electric heating element;
an adjustable thermostat to regulate the amount of heat generated by the electric heating element;
an electric fan;
a connector port coupled to said heating element and fan, wherein said heating element and fan receive electricity through said connector port;
a power cord that connects said connector port to an external source of electricity;
a generally one piece non-metallic body with vents at front and rear to allow for airflow with said body containing said heating element, thermostat, fan and connector port;
two metal adaptors mounted at the front exterior and rear exterior of the body which allow for connection of said body to heat-resistant tubing comprised of metal, plastic, resin, fiberglass or any combination thereof;
two metal fasteners which connect the heat-resistant tubing to the tubing adaptors.

2. A method of pre-heating an aircraft engine in preparation for cold weather flight comprising;
use of the apparatus in claim 1 in conjunction with an aircraft engine.
